(19) United States
(12) Patent Application Publication
(10) Pub. No.: US 2015/0095077 A1
(43) Pub. Date: Apr. 2, 2015

(54) METHOD AND APPARATUS FOR HIRING WORKERS

(71) Applicant: EPAY SYSTEMS, INC., Chicago, IL (US)

(72) Inventor: Frank Ruffolo, South Barrington, IL (US)

(73) Assignee: EPAY SYSTEMS, INC., Chicago, IL (US)

(21) Appl. No.: 14/043,801

(22) Filed: Oct. 1, 2013

(51) Int. Cl. G06Q 10/10; G06Q 40/00

(52) U.S. Cl. CPC G06Q 10/1053; G06Q 40/125
USPC 705/7.13; 705/32

(57) ABSTRACT

An apparatus, system and/or method that incorporates teachings of the present disclosure may include, for example, transmitting to a human resources system application information and permission to perform a background check for a job opening, where the application information and the permission are inputted by an applicant via a user interface of a time clock device, presenting a job offer from the human resources system to the applicant via a graphical user interface, receiving an acceptance of the job offer inputted by the applicant via the user interface to make the applicant a worker, capturing work time information for the worker via the user interface, and transmitting the work time information to a payroll system. Other embodiments are disclosed.

### FIELD OF THE DISCLOSURE

The present disclosure relates generally to hiring workers and a method and apparatus for hiring workers.

### BACKGROUND

Management of employees typically requires interaction with the employees to fulfill a number of different desires of the employees. In centralized working environments, such as where each employee or perspective employee is located at the same facility with supervisors and/or human resources personnel, desired interactions can be readily implemented. However, such interactions can be difficult in other situations, such as in distributed work environments. For example, large corporations may include many locations, including satellite locations, where some locations may not include a full complement of supervisors and/or human resources personnel.

### BRIEF DESCRIPTION OF THE DRAWINGS

The exemplary embodiments may be understood by reference to the following description taken in conjunction with the accompanying drawings, in the several figures in which like reference numerals identify like elements, and in which:

FIG. 1 is an illustrative embodiment of an electronic terminal in accordance with one or more of the exemplary embodiments;

FIG. 2 is a block diagram of the electronic terminal illustrated in FIG. 1;

FIG. 3 is an illustrative embodiment of a communication system in accordance with one or more of the exemplary embodiments and in which the electronic terminal of FIG. 1 can operate;

FIG. 4 is an illustrative embodiment of another communication system in accordance with one or more of the exemplary embodiments and in which the electronic terminal of FIG. 1 can operate;

FIG. 5 is an illustrative embodiment of the central processing server array of the communication system illustrated in FIG. 4;

FIG. 6A depicts an illustrative embodiment of a method operating in portions of one or more of the devices and systems of FIGS. 1-5;

FIG. 6B depicts an illustrative embodiment of a method operating in portions of one or more of the devices and systems of FIGS. 1-5;

FIG. 7 depicts an illustrative embodiment of a method operating in portions of one or more of the devices and systems of FIGS. 1-5;

FIG. 8 depicts an illustrative embodiment of a communication device utilized in the communication systems of FIGS. 3-4 and the method of FIGS. 6 and 7; and

FIG. 9 is a diagrammatic representation of a machine in the form of a computer system within which a set of instructions, when executed, may cause the machine to perform any one or more of the methods disclosed herein.

### DETAILED DESCRIPTION

One or more of the exemplary embodiments can include an apparatus having a memory to store computer instructions, a user interface, a display device, and a controller circuit. The controller circuit can be coupled to the memory, the user interface and the display device. Responsive to executing the computer instructions, the controller circuit can perform operations for presenting a self-service graphical user interface on the display device comprising instructions to apply for a job opening. The controller circuit can perform operations for receiving application information for the job opening inputted by an applicant via the user interface, receiving a permission to perform a background check inputted by the applicant via the user interface, and transmitting the permission to a human resources system. The controller circuit can also perform operations for receiving a notification from the human resources system and determining whether the notification comprises a job offer to the applicant. Responsive to determining the job offer, the controller circuit can further perform operations for presenting the job offer to the applicant via the self-service graphical user interface and receiving an acceptance of the job offer inputted by the applicant via the user interface to make the applicant a worker. The controller circuit can, in turn, perform operations for capturing a check-in time and a check-out time for the worker via the user interface, calculating a work time corresponding to a period between the check-in time and the check-out time, and transmitting the work time to a payroll system.

One or more of the exemplary embodiments can include a computer-readable storage medium having computer instructions that, when executed by a processor, cause the processor to perform operations for presenting a self-service graphical user interface comprising instructions to apply for a job opening at a display device of a time clock. The processor can also perform operations for receiving application information for the job opening inputted by an applicant via a user interface of the time clock and transmitting the application information to a human resources system. The processor can further perform operations for receiving a notification from the human resources system responsive to transmitting the application information and determining whether the notification comprises a job offer to the applicant. Responsive to determining the job offer, the processor can perform operations for presenting the job offer to the applicant via the self-service graphical user interface and receiving an acceptance of the job offer inputted by the applicant via the user interface to make the applicant a worker. In turn, the processor can perform operations for capturing a check-in time and a check-out time for the worker via the user interface and calculating a work time corresponding to a period between the check-in time and the check-out time.

One or more of the exemplary embodiments can be a method including transmitting to a human resources system, by a time clock device comprising a processor, application information and permission to perform a background check for a job opening. The application information and the permission can be inputted by an applicant via a user interface. The method can also include presenting, by the time clock device, a job offer from the human resources system to the applicant via a graphical user interface and receiving, by the time clock device, an acceptance of the job offer inputted by the applicant via the user interface to make the applicant a worker. The method can further include capturing, by the time clock device, work time information for the worker via the user interface and transmitting, by the time clock device, the work time information to a payroll system.

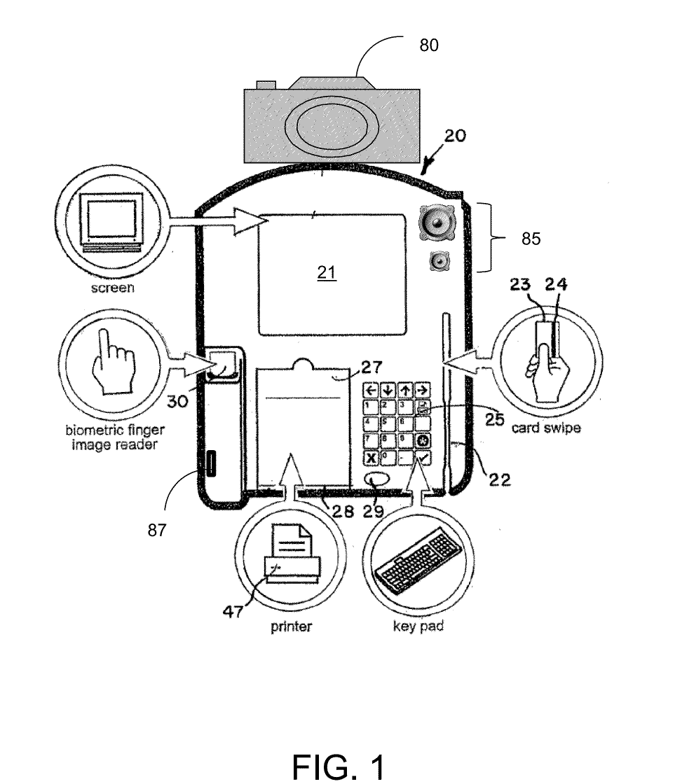

Referring to the Figures, and particularly to FIG. 1, an electronic terminal is illustrated and generally indicted by reference numeral 20. Electronic terminal 20 can include ATM, payroll and/or work management capability. Terminal 20 can be a processing device that can be installed or otherwise provided at a desired location, such as at one or more remote facilities of an employer, customer and so forth. The terminal 20 can be installed via hardwire coupling of the processor to communication and/or power lines of the facility. As an example, the terminal 20 can be a relatively light-weight apparatus that can be delivered to the desired location and then installed through coupling various communication and power lines. Other installation steps can also be taken, such as securing the terminal 20 to infrastructure at the particular location.

Terminal 20 can include a display screen or device 21 for displaying various selectable and non-selectable content, such as, options, commands, work assignments, messages, and/or scheduling information. The source of the content can vary and can include the memory of the terminal 20 and/or remote sources. Display 21 can be of various types, such as a liquid crystal display (LCD) type. The terminal 21 can be positioned at various locations, including areas that employees utilize to check-in or check-out of work, such as at the employer's facilities or at the customer's facilities in those instances where the employees work at the customer's facilities (e.g., a construction site or janitorial or cleaning staff). The terminal 20 can be positioned at locations frequented by potential employees, such as a reception area of the employer or at public locations, such as recreational or shopping areas.

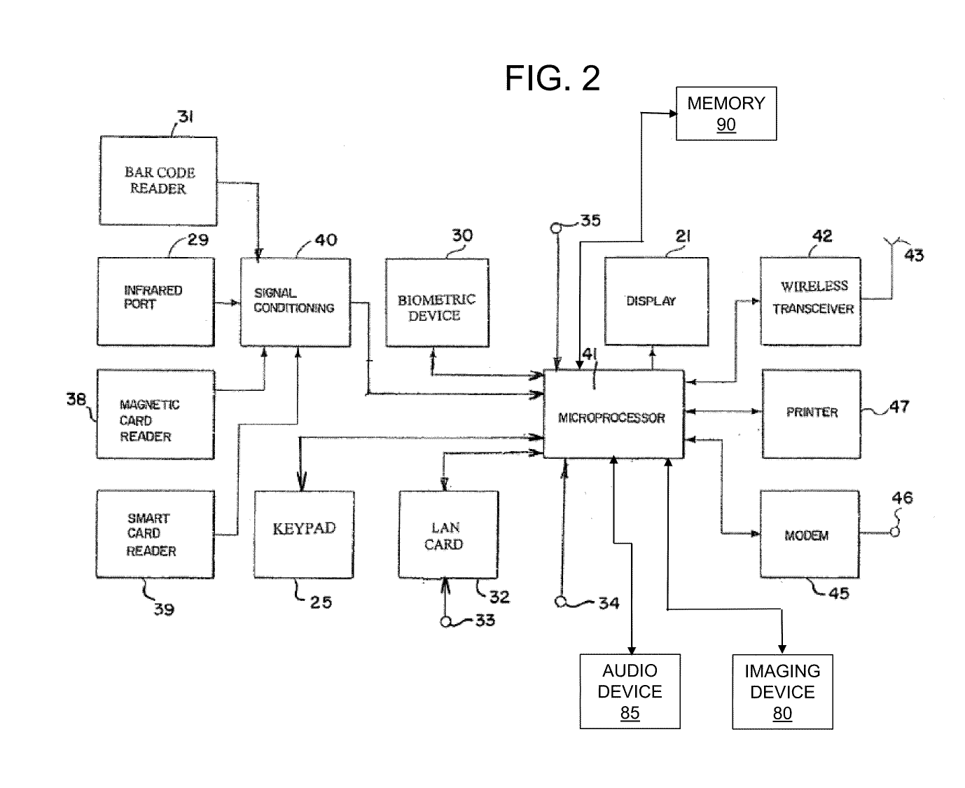

Referring additionally to FIG. 2, terminal 20 can include a reader device, such as card reader 38. In one embodiment, the card reader 38 can be a magnetic card reader including a slot 22 for reading a card 23, such as a bank card, an identity card, and/or other card that stores information thereon. Terminal 20 can also include a keyboard or keypad 25, a printer port 28 and a biometric device 30. The terminal 20 can include a communications port 87 for connecting a memory card and/or computing device. For example, the communications port 87 can provide a universal serial bus (USB) compatible interface for transferring files between the terminal 20 and a memory card and/or computing device.

Card reader 38 can read the information contained on a magnetic stripe 24 of the card 23, such as a bank account number, a personal identification number, or an employee number. For example, card 23 can be a card issued by a bank and the magnetic stripe can have a unique identifying number encoded therein which corresponds to one or more accounts at the bank. In another example, the Terminal 20 can also read information from smart cards utilizing smart card reader 39. In one embodiment, card 23 and/or a smartcard can be used with the terminal 20 as an ATM, payroll and work management card as described more fully in U.S. Patent Application No. 20080041942, U.S. Pat. No. 7,229,013 and U.S. Pat. No. 6,764,013, the disclosures of each of which are hereby incorporated by reference. It should be understood that one or more of the components and/or method steps described with respect to U.S. Patent Application No. 20080041942, U.S. Pat. No. 7,229,013 and U.S. Pat. No. 6,764,013 can be used with, or in place of, one or more of the components and/or method steps described with respect to the exemplary embodiments in the present application.

Keypad 25 can include a plurality of keys for entering alpha-numeric information, for scrolling through the information displayed on display 26, for accessing a prior page or the next page for entering selected information, and the like. In addition to the keypad 25, or in place thereof, the display 21 can be a touch sensitive screen that can function similarly to the keypad to enable the entry of alpha-numeric information as well as allow for selection and scrolling through a variety of information, including selectable options. In one embodiment, the touch-sensitive screen can present the key pad in a select area of the screen (e.g., so as not to block selectable options or an ongoing video conference) and/or can present the keypad in a semi-transparent fashion so that other content can be seen simultaneously with the keypad.

In one embodiment, the keypad can include one or more hotkeys (e.g., a key with a circular indicia) for starting desired functions such as reading a fingerprint on biometric device 30, a key with a printer symbol for printing the current screen appearing on display 21, a star button to continue a desired function, a key with a check mark for approving or responding to specific inquiries or options, and/or a key with an “X” indicia for exiting the present function or for deleting information entered into terminal 20.

Printer port 28 can include a printer 47 disposed behind an access door 27 and space for provisioning the terminal 20 with a source of paper (e.g., a roll of paper located behind the access door). In one embodiment, when the terminal 20 is instructed to print, the printed paper from a roll can be dispensed through the printer port 28 such that the user may tear it off against the forward edge of the port. As an example, an authenticated employee may obtain a print-out of desired information associated with the user, such as a human resources approval of a scheduling request, a supervisor approval of a scheduling request, a receipt for cashing in a Paid Time Off (PTO) day, confirmation of a PTO day rolled to another fiscal period and/or a payroll stub relating to the most recent pay period including details about gross pay, deductions and net pay. It should be understood that a PTO day can include a whole or portion of an entire work day and can include various types of PTO days, including vacation days, administrative paid leave, personal days, sick days, and so forth.

In another embodiment, the terminal 20 can print information useful for various aspects of hiring a new employee, such as completing an employment application, verification that an applicant has entered the application, verification of permission to perform a background check, an offer for employment, a rejection of the applicant, and/or scheduling information for completing employment processing. Other types of printed information obtained from terminal 20 may include current work assignments and/or locations, recent activity and balances in bank accounts related to the unique number of the card, and the like. The results of work quality audits may also be made available for printing. In one embodiment, a supervisor can obtain a printed copy of scheduling information (e.g., schedules of other employees, work load for a user requesting a schedule adjustment, work load for the user's department or affiliated employees, predicted work production based on a scheduling request, alternative scheduling for the user and/or other information associated with the user or associated with co-workers of the user).

Terminal 20 can include a biometric device 30 for sensing or otherwise obtaining biometric information from a user seeking access to the terminal in order to authenticate the identity of the user. For example, the biometric device 30 can be a fingerprint reader and comparator (hereinafter fingerprint reader); although other biometric data can also be utilized, including voice recognition, facial scans, eye scans, and so forth. Due to the unique characteristics of human fingerprints, the fingerprint reader 30 may be used as an initial or primary form of employee or prospective employee identification and authentication, or to supplement the card reader 22 in its reading of the card 23 (or other card storing employee-related information). The fingerprint reader 30 enables access to the terminal even though a user may forget or lose their card.

The terminal 20 can also include an infrared communications port 29 to communicate with other devices that also utilize infrared communication means. For example, a supervisor of employees or a customer of employment services may have information about new or current work assignments, such as stored on a mobile communication device (e.g., a Personal Digital Assistance (PDA) or a smart phone) which can transfer the information to the terminal 20 via the infrared port. The terminal 20 can also be capable of utilizing other modes of communication, including wired and wireless communication, that can be used with mobile or fixed communication devices, including via the wireless transceiver 42 (which can be a multi-mode component capable of communication utilizing any number of different communication protocols either sequentially or simultaneously) shown in FIG. 2. For example, the terminal 20 can include a wireless fidelity (WiFi) capable communication link that can support WiFi communications between the terminal 20 and a computing device, such as a smart phone, a computer, and/or a mobile communication device.

Terminal 20 can include an imaging device 80 which is integrally formed with the terminal and/or coupled thereto (e.g., through tethered or wireless communication). In one embodiment, the imaging device 80 can be retrofitted (e.g., via tethering and/or wireless communication) onto already existing terminals 20 that are in use at facilities. Imaging device 80 can capture still and/or moving images of an individual utilizing the terminal 20. The particular components and techniques utilized in imaging device 80 for capturing the images can vary and can include utilizing a digital camera. The imaging device 80 can be used for capturing an image of an employee and/or a perspective employee for purposes of current and/or future identification. The imaging device 80 can further capture an image from a card, such as an identification card associated with an employee and/or perspective employee for purposes of verifying that the person presenting the card is the proper bearer of the card. The imaging device 80 can also provide images captured at the terminal 20 to other devices that can used the data for authentication and/or checking background information with respect to the employee and/or applicant for employment.

Terminal 20 can include an audio interface 85 which is integrally formed with the terminal or coupled thereto (e.g., through tethered or wireless communication). Audio interface 85 can include a microphone and speakers for capturing and presenting audio signals, such as the speech of an individual utilizing the terminal 20. The particular components and techniques utilized in audio interface 85 for capturing and presenting the audio signals can vary. The audio interface 85 can be used to provide instructions, feedback, and/or further information to an employee and/or applicant for employment. The audio interface can also capture a sample of speech from an employee and/or applicant for employment for use in identifying the person giving the sample.

Terminal 20 can include a bar code reader 31 which may be used to read the bar codes on supplies and/or products associated with the work environment of the user of the terminal. Thus, the inventory of supplies and/or products may be tracked. The bar code reader 31 can be of a wired and/or wireless type.

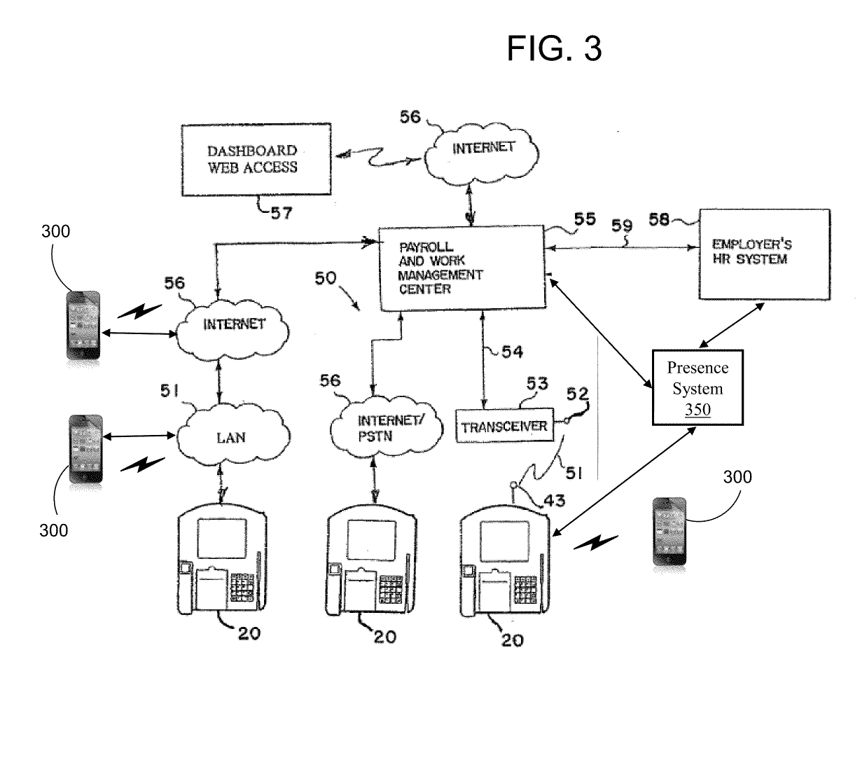

Information signals from the magnetic card reader 38, the smartcard reader 39, the bar code reader 31, the infrared port 35, the communications port 87, the imaging device 80, and/or the audio interface 85 can be conditioned by signal conditioning circuitry 40 to provide input signals that are compatible with input terminals of a microprocessor 41 of the terminal 20. The microprocessor 41 can include or otherwise be coupled with a memory 90 for storage of information therein. The biometric device 30, the imaging device 80 and/or the audio interface 85 may in one embodiment interface directly with the microprocessor 41. A Local Area Network (LAN) card 32 can also interface with the microprocessor 41 to provide further connectivity in the system 50 (shown in FIG. 3) via the I/O port 33. Microprocessor 41 can also receive inputs from the keypad 25. Microprocessor 41 may be any suitable microprocessor, microcontroller, data processor or the like.

Any of the information provided to terminal 20 may be communicated to a computer or database, which may be remotely located. For example, microprocessor 41 can supply input information to the radio frequency (RF) transceiver 42 for transmission via an antenna 43. The path of RF transmission can be by conventional antenna-to-antenna RF transmission, a microwave link, a satellite link, or the like. Terminal 20 can receive information from a remotely located computer or database via RF transmission in the reverse direction, such as from antenna 43 to RF transceiver 42 to microprocessor 41. Microprocessor 41 can provide some of the received information for display on the display screen 21. The transceiver 43 can operate using one or more modes of communication, individually or simultaneously, including short-range communications (e.g., Bluetooth, WiFi, Zigbee) and long-range communications (e.g., LTE, WiMAX, GSM, CDMA). In one embodiment, the transceiver 43 is a plurality of transceivers that can communicate utilizing different modes of communication.

The microprocessor 41 in terminal 20 preferably has sufficient dedicated memory, either internally at memory 90 or externally, to store various information such as unique account numbers of cards and PINs of the employees that frequently use any particular terminal 20 or other information that is desired to be stored locally, such as pending scheduling requests, pending scheduling decisions and/or user profiles. In one embodiment, authentication of employees can be done internally at terminal 20 without having to communicate with a remote computer to access the appropriate account numbers and PINs. In one embodiment, terminal 20 can communicate with a remote computer or database to provide other information associated with a user of the terminal, such as the check-in and checkout times for processing of the payroll.

Terminal 20 can also communicate, separately or in tandem with the RF link, via a modem 45. Modem 45 can have an output terminal or jack 46 to communicate bi-directionally with a remotely located computer or database utilizing one or more of the Public Switched Telephone Network (PSTN), internet, Virtual Private Network (VPN) or the like.

Referring additionally to FIG. 3, there is shown an employment application, ATM, payroll and/or work management (APW) system, generally indicated by reference numeral 50. One or more terminals 20 are included in or in communication with the system 50. The terminals 20 can be located at different facilities or at the same facility but at different locations within the facility. Any number of terminals 20 in various configurations can be provided, although three are shown.

One of the terminals 20 is shown with an antenna 43 to transmit radio waves 51 to the antenna 52 of a transceiver 53, which in turn can communicate with a payroll and work management center 55 via one or more lines 54 (and/or wirelessly). While antennas 43 and 52 of terminal 20 and transceiver 53, respectively, are shown as external antennas, it will be appreciated that these antennas 43 and 52 can be internally disposed within the respective terminals. The other terminal 20 can communicate with center 55 via the internet or the PSTN 56. Yet another terminal 20 can communicate with center 55 via a LAN 51 and the internet 56. Thus, the modes and paths of communication between the terminals 20 and the center 55 can vary.

The center 55 can include one or more computers or servers with memory for storing the names of employees, the pay rate for each employee, any deductions from pay for health insurance or the like, the number of the unique card that has been assigned to each employee and/or the PIN associated with each card. The center 55 can include or otherwise store other information, such as scheduling information associated with employees at a location, user profiles associated with employees at a location and so forth. It should be understood that the other information can be stored at the center 55 and/or at other locations, including at each of the terminals 20 or the Human Resources (HR) system 58.

Center 55 can have additional pertinent information concerning one or more of the employees, such as mailing addresses, telephone numbers, communication devices associated with the employees and so forth. In one embodiment, center 55 can obtain information from the employer's HR system 58 via a communication line 59 (and/or wirelessly). The employer's HR system 58 can provide updated employee information to the center 55, such as periodically, as new employees are hired, when the status of an employee changes, and so forth. In one embodiment, dashboard web access 57 can enable real-time monitoring of the status of the system 50, including information on employees that are registered on the system, the number of employees that have checked into work at any particular site, pending scheduling requests for employees, recent scheduling decisions by supervisors, and the like.

In one embodiment, center 55 can also record the time of check-in and the time of checkout for each employee to determine the amount of work time. The pay for each employee can be calculated based upon the recorded work time and the pay rate for each employee. Center 55 can advise the employer of the amount of the payroll. Center 55 can perform an electronic funds transfer (EFT) from employer's bank in the amount of the payroll so that each employee's bank account associated with each bank card 23 will be credited in the net amount of pay for that pay period. The amount of pay can include PTO days that have been cashed, such as through use of the terminal 20. The bank card 23 can be used as a debit card against available funds at point of sale (POS) locations, such as at department stores, grocery stores, gas stations or the like.

In one embodiment, a prospective employee can use a terminal 20 as an entry point for applying for employment. For example, the terminal 20 can provide a user interface to a job applicant. The applicant can select a function at the user interface of the terminal 20 for beginning a job application process. The applicant can provide one or more credentials for identifying the applicant. For example, the applicant can provide information such as her name, a social security number, address of residence, and/or phone number. The terminal 20 can capture this information using one or more of the available functions for voice recognition using audio interface 85, text entry via the keypad 25, still image/video capture via the imaging device 80, and/or the communications port 87. For example, an applicant could enter an image of herself via the imaging device 80, download a resume via the communications port 87, enter a telephone number via the keypad 25, provide an identification number via a magnetic card via the card reader 22, provide a fingerprint via the biometric image reader 30, and respond to audio instructions via the audio interface 85.

The terminal device 20 can transmit application information captured at the terminal device 20 to the human resource (HR) system 58. In one embodiment, the HR system 58 can simply capture and store the information provided by an applicant for future reference in recruiting and/or hiring. In another embodiment, the HR system 58 can process the application through all or part of an employment process. The terminal device 20 can request further information from the applicant. The terminal device can provide information to the applicant regarding a live or in-person interview. For example, the terminal device 20 can print out information for an in-person interview. In one embodiment, the terminal device can be used for interviewing an applicant. For example, the imaging device 80, audio interface 85, and/or display 21 can be used for conducting an interview with personal linked to the terminal 20 via the HR system 58.

In one embodiment, the terminal device 20 can request permission from the applicant for conducting a background check. For example, the applicant can provide written, verbal, and/or electronic permission for the employer to perform a background check on the applicant. The HR system 58 can perform a background check and/or can direct a third party to perform a background check. For example, the applicant's legal, criminal, and/or financial history can be verified using one or more services available over the internet 56. In another embodiment, the HR system 58 can access a system to verify the legal status of the applicant, such as the Federal E-Verify system. The terminal device 20 can capture information associated with one or more references and transmit this information to the HR system 58. Personnel at the HR department can contact references provided by the applicant. In another embodiment, the terminal device 20 can capture additional information form the applicant for use in further evaluation of the application, such as a resume or cover letter. For example, the applicant can download information into the terminal 20 via the communication port 87. The downloaded information can be transmitted to the HR system 58 for storage and evaluation.

In one embodiment, the HR system 58 can make an immediate determination regarding the application. For example, the HR system 58 can determine that no new employees are needed at this time or that the applicant is disqualified for the job due to an issue revealed in the background check. In such a case, the HR system 58 can send a notification to the terminal 20 informing the applicant that no employment opportunities are available at this time or that the application is rejected. In another embodiment, the HR system 58 can determine that a provisional employment offer will be made to the applicant based on the information provided by the applicant and the available employment opportunities. The HR system 58 can send a notification to the terminal 20 notifying the applicant of the provisional offer.

In one embodiment, the terminal device 20 can provide the applicant with an option to respond to the employment decision that is send from the HR system 58. For example, the terminal device 20 can provide an opportunity for the applicant to provide additional information in furtherance of the employment application. The terminal device 20 can provide information to the applicant regarding a starting wage and/or starting date for employment. The terminal device 20 can provide the applicant with an opportunity to immediately accept the provisional offer of employment. For example, the applicant can be asked to electronically sign an agreement to accept the job using the display 21 and/or keypad 25. Alternatively, the applicant can accept the offer verbally using the audio interface 85. In another embodiment, the HR system 58 can send a notification to the terminal device 20 notifying the applicant that the employer has not current job opening but would like to retain the information provided by the applicant for future assessment. The applicant can be given an opportunity to decide if she wants the HR system 58 to retain the application information or to discard this information.

One or more communication devices 300 can be in communication with the terminals 20 via the PSTN, internet, LAN and/or wirelessly. The communication devices 300 can be wired devices and/or wireless devices, and can be personal devices or employer-owned devices. The communication devices can also communicate with one or both of the center 55 and the HR system 58. In one embodiment, a presence system 350 can be utilized for generating and maintaining presence information associated with the employees and supervisors, such as through monitoring of communication devices 300 of the employees. For example, the presence system 350 can include one or more presence servers that are aware of various communication devices 300 associated with an employee or supervisor, such as identified by a user profile of the employee or supervisor, and can monitor activity associated with those communication devices, including network authentication, GPS data acquisition, roaming activity and so forth. In one embodiment, polling of the communication devices 300 can be performed to provide more up-to-date presence information for the employee or supervisor, which may or may not include location information for the employee or supervisor. The presence system 350 can be accessed by one or more of the terminals 20, the center 55 and/or the HR system 58 for determining presence of the employee and/or supervisor.

The presence system 350 is depicted in FIG. 3 as being a stand-alone system, which may or may not be operated by a third party, but the exemplary embodiments can include the presence system being integrated with one or more of the terminals 20, the center 55 and/or the HR system 58, including in a distributed or centralized fashion. The exemplary embodiments can also include synchronization techniques with respect to various data that is stored at more than one location. For instance, scheduling information may change based on decisions that are received or otherwise obtained at a terminal 20, and the adjustments to the scheduling information that are being stored at multiple locations, such as at the HR system 58 and the center 55, may be synchronized. User profiles associated with employees and supervisors at a first location may be stored at a terminal 20 at the first location as well as at the HR system 58, and one of the user profiles can be synchronized across the various storage devices upon a change to the user profile (e.g., a user preference not to be contacted on a home telephone number). In one embodiment, the presence system 350 can be used to insure that the applicant is actually present at, or near, the terminal device 20. This feature can be used to prevent fraud by individuals impersonating an applicant and to prevent third parties from entering large numbers of applications into the HR system 58.

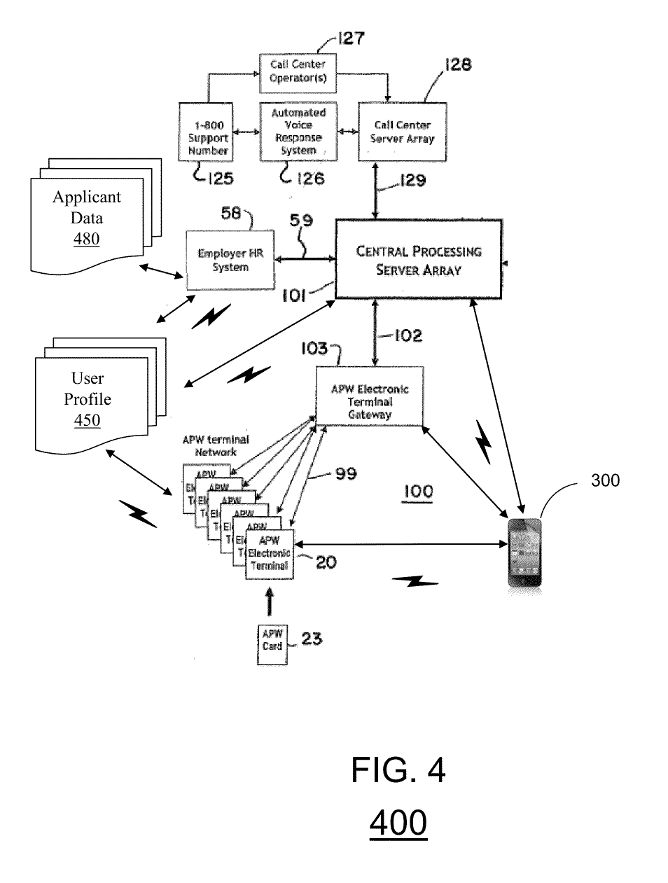

Referring to FIG. 4, a system 400 is shown in which a plurality of terminals 20 communicate via links 99, which may be via a wired connection such as an internet or PSTN link 56 or via a wireless link 51 to an APW electronic terminal gateway 103. Gateway 103 can include modems and transceivers to receive the communications from the terminals 20. Gateway 103 can also include a firewall or other components and/or techniques to protect a central processing server array 101 from unauthorized access. Information to and from the terminals 20 can be communicated between the array 101 and the gateway 103 via lines 102 (or wirelessly). Gateway 103 can be physically located near array 101 or gateway 103 can be located at an employer's site where it communicates with a plurality of terminals 20. The array 101 can represent a portion of, or otherwise operate in, the center 55 of FIG. 3.

User profiles 450 can be stored by one or more of the array 101, the HR system 58 and/or the terminals 20. The user profiles 450 can be stored in a distributed manner, such as being stored locally only at a terminal 20 where the corresponding employees while also being stored at one or both of the array 101 and the HR system 58. In one embodiment, the user profiles are only stored locally at the terminals 20 so that information contained in the user profiles is not being transmitted to and from remote devices. The user profiles 450 can include various information, such as identification information for the user, information descriptive of communication device(s) 300 associated with the user (e.g., device ID information, formatting capability), preferences of the user, skill sets of the user, work efficiency information for the user, and so forth. For example, the user profile 450 can include user preferences for contacting the user via one or more of the communication devices 300, such as times to contact the user via a first communication device and times to contact the user via a second communication device. Skill sets of the user, such as provided by the HR system 58 and/or a supervisor of the user, can be included in the user profile to describe capabilities of the user with respect to performing various tasks at work. This information can be utilized as part of the analysis of scheduling information to provide scheduling options for selection by the user and/or for assisting a supervisor in making a scheduling determination. The user profiles can be linked or otherwise associated with other user profiles for individuals that work with a select user, including supervisors of the user, co-workers of the users, and subordinates of the user. By linking or otherwise associating user profiles, the analysis of scheduling information can be facilitated by making information associated with related workers more readily available, such as to determine whether a requested PTO day will impact a department's ability to achieve a work goal based on efficiencies or skill sets of the relevant and available workers.

In one embodiment, applicant data 480 can be stored by one or more array 101, the HR system 58, and/or the terminals 20. The applicant data 480 can also be stored in a distributed manner, such as local storage only at one or more terminals 20 and/or stored in one or both of the array 101 and the HR system 58. In one embodiment, the applicant data 480 can be stored only at the HR system 58 to provide enhanced security and privacy. The applicant data 480 can contain a variety of information that is associated with each applicant. For example, the applicant data 480 can include name and contact information, electronic copies of a resume and/o cover letter, an electronic copy of an employment application received at the terminal device 20, data from one or more background checks, samples of fingerprints, voice audio, and/or face image, and copies of driver's licensing and/or professional licensing cards and/or certificates. The applicant data 480 can also include information about the applicant's work history, working skills, preferred hours, working efficiency, and/or scheduling. The HR system 58 can use the information in the applicant data 480 to make a determination for hiring the applicant and/or retaining or promoting applicant as an employee. The system 100 can transfer all or part of the information in the applicant data 480 into a user profile for the applicant once the applicant transitions to the status of employee.

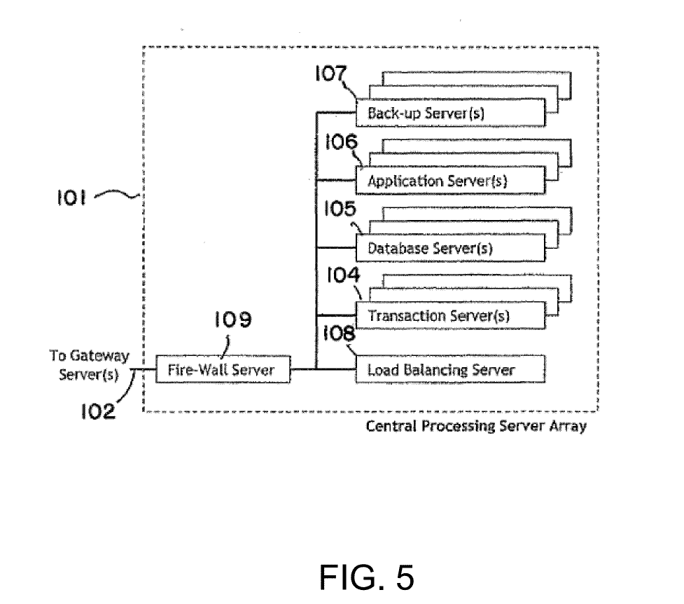

Central processing server array 101 is shown in greater detail in FIG. 5. Array 101 can include a plurality of servers, such as a plurality of transaction servers 104, a plurality of database servers 105, a plurality of application servers 106, a plurality of back-up servers 107 and/or a firewall server 109. The server array 101 can be implemented in a variety of other ways, such as with an Intel™-based computer, a Unix™-based computer, a mainframe computer or the like. Array 101 can operate in as a special purpose computer to receive, send, process and store information.

A plurality of server arrays 101 can be distributed in selected locations in a nationwide system. The terminals 20 can then generally communicate with the nearest server. Back-up servers can also be provided to prevent the loss of stored information and to provide continued processing services in case any one server array becomes non-functional. The system 400 can also include a call center including a toll-free support number 125, an automated voice response (AVR) system, one or more call center operators and/or a call center server array 128. Thus, an employee or applicant having difficulty with any terminal 20 may call the toll-free number for help with a scheduling request, a transaction, system status, payroll or balance inquiries or the like. Call center operators 127 may have a personal computer to access the central processing server arrays 101 via the call center server array 128 to obtain information about the inquiring employee's account by first logging into central processing server array 101. When using the AVR system 126 from a remote telephone, the inquiring employee can use the matrix of keys on the telephone to access the desired information by following the commands issued by the voice response system. The employee can log onto array 101 by entering the bank account number on the bank card 23 and then entering the associated PIN or by use of the fingerprint reader 30 or other authentication technique (such as voice or facial recognition), or a combination of these processes depending upon the desires of the employer.

In one embodiment, the terminal 20 can provide a means for entering employee hours worked. A new or existing employee can enter hours worked into the any terminal 20 that has been provisioned by the employer for accepting working time information. In one embodiment, hours are entered automatically as the employee clocks-in/clocks-out using a credential. For example, the employee can use the card reader 22 to swipe a badge or an identification card that identifies the employee. In another example, the employee can use the fingerprint reader 30 or the audio interface 85 to provide a fingerprint or a voice sample as a credential. The terminal 20 can authenticate the provided credential locally or can transmit digital data from the credential to a central authentication process for authentication. After the credential is authenticated, the terminal 20 can log check-in/check-out information for the employee identified by the credential. The terminal can forward the check-in/check-out log to a payroll and work management server 55. The payroll and work management server 55 can maintain an official and permanent record of the hours that each employee works.

In one embodiment, the terminal 20 can provide a means for employee verification of the log of hours worked. In one embodiment, the terminal 20 can provide the hours worked verification function at a user interface of the display 21 for the employee to view the log of hours worked for the past week, month, year, or other period. Selection of the hours verification function can cause the terminal 20 to request the log of hours worked for this employee from the payroll and work management server 55. In one embodiment, the hours worked verification function can be automatically invoked by the terminal whenever the employee clocks-in/clocks-out to require the employee to verify the accuracy of the log of hours worked for the previous time period (e.g., the previous day or week). In one embodiment, the hours verification function can be automatically invoked a according to a schedule. For example, the hours worked verification function can be automatically invoked at the time of the first clock-in to begin of a new work week for the purpose of verifying the previous week's time.

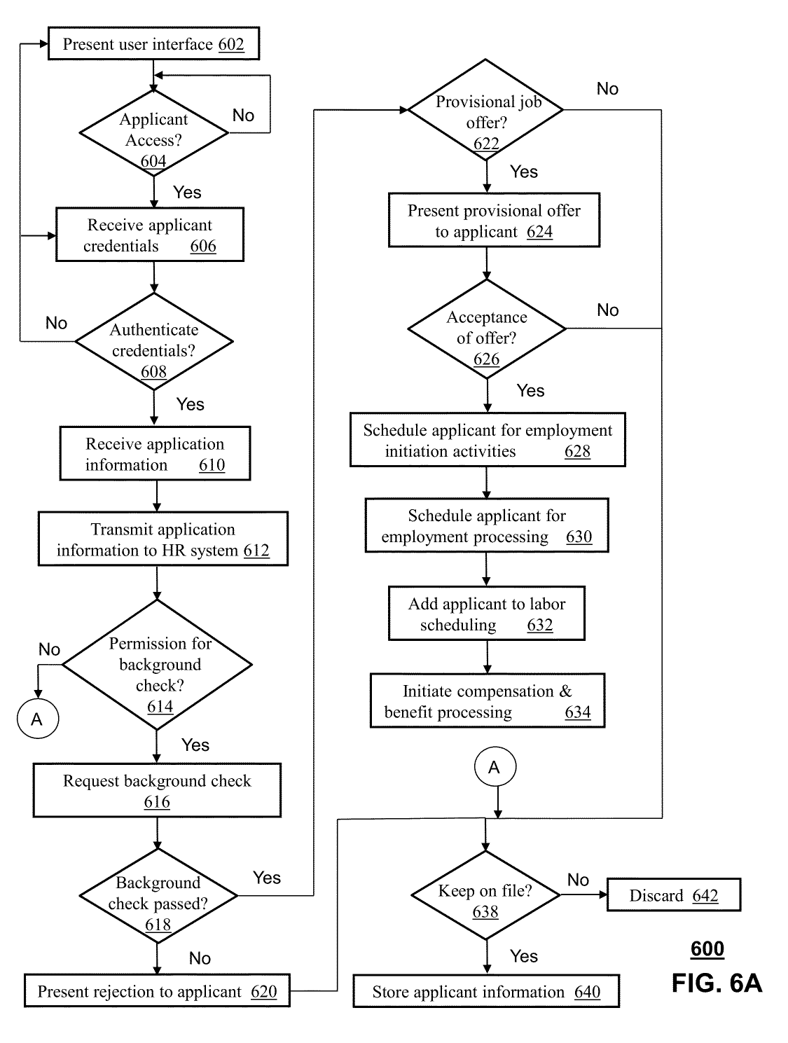

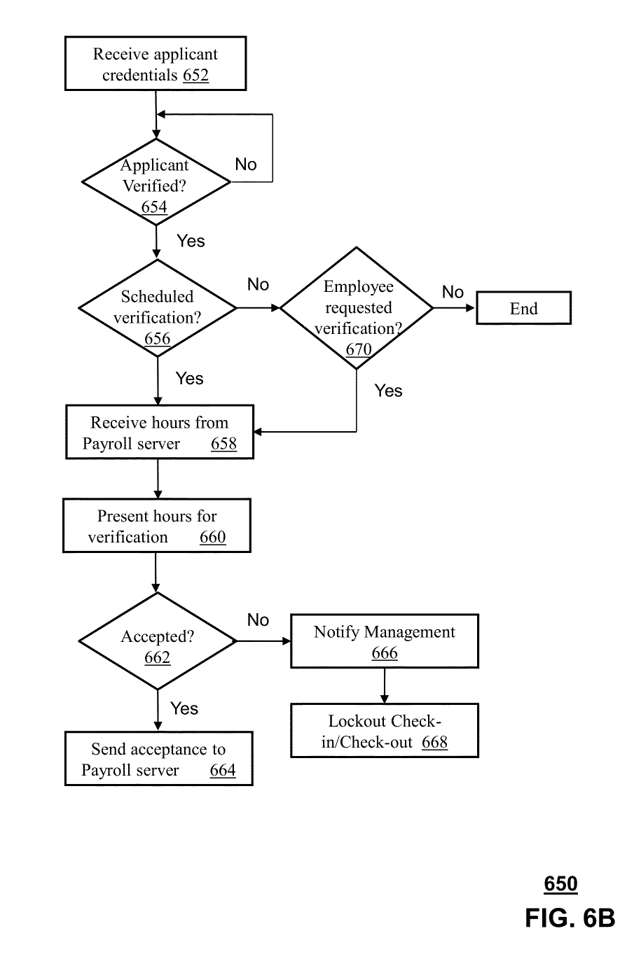

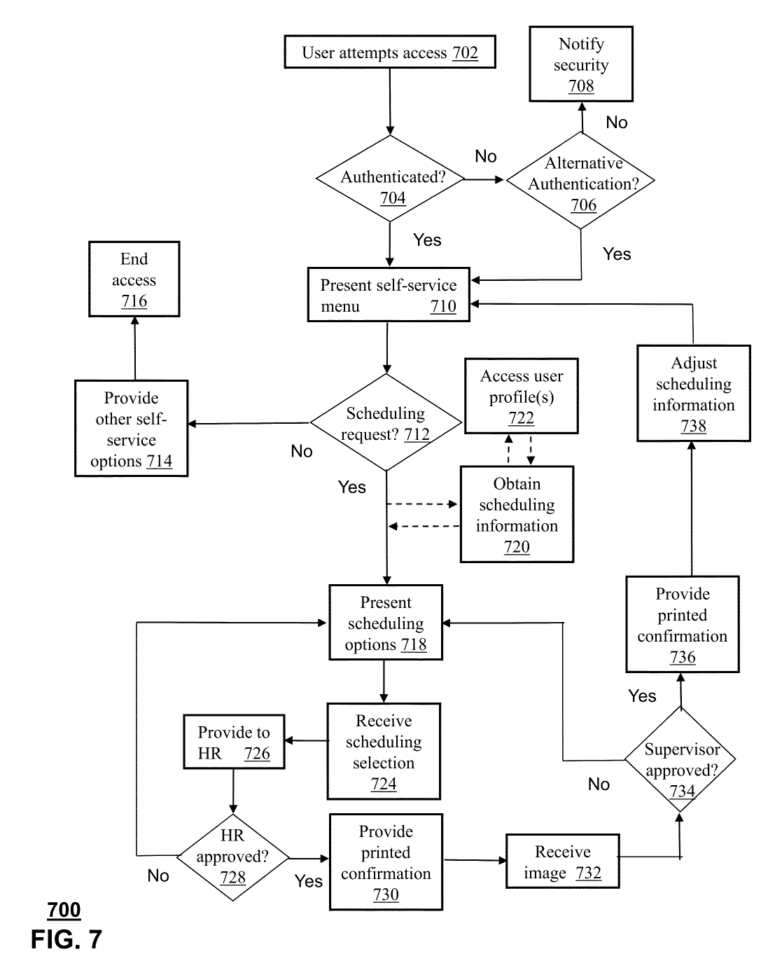

In one embodiment, the terminal 20 can provide one or more means for the employee to verify the log of hours worked. For example, the terminal 20 present the log of hours worked and ask the employee if the provided data is correct. If the terminal 20 has automatically invoked the verification based on the employee entering a credential, then the terminal 20 can simply ask the employee to answer using the display 21, the keypad 25, and/or the audio interface 85. Alternatively, the terminal 20 can require the employee to re-enter the credential or to provide an additional credential to verify the logged working hours. In one embodiment, the terminal 20 can ask the employee to simply accept or reject the log of hours as correct. If the employee accepts the log as correct, then the terminal 20 can provide the verification to the payroll and work management server 55. Conversely, if the employee rejects the log, then the terminal 20 can provide the rejection to the payroll and work management server 55. If the employee rejects the log of hours worked or refuses to answer, then the terminal 20 and/or the payroll and work management server 55 can notify management to intervene and resolve the dispute. In one embodiment, the terminal 20 can provide a means for the employee to enter a comment to dispute the log of hours. In one embodiment, the terminal 20 can lock out further check-in/check-out by the employee until the employee either verifies the hours worked or management resolves the dispute. FIG. 6A depicts an illustrative method 600 that operates in portions of the devices and systems of one or more of FIGS. 1-5, 8, and 9, and the method of FIG. 7. Method 600 can begin at 602 with a terminal 20 presenting a user interface. In one embodiment, the terminal 20 can present an interface at the display 21 of the terminal 20. The interface can be text only or a combination of text and graphics. The interface can prompt the user to enter responses and text via the keypad 25. Alternatively, if the display 21 is a touch screen, then the user interface can include an on-display keypad for entering responses and text. The user interface can include information describing the company, job openings, and/or qualifications for the available positions. The user interface can also include instructions for using the terminal function by entering and receiving data and information via the display 21, the keypad 25, the card reader 22, the communications port 87, the audio interface, the imaging device 80, the biometric device 30, and the printer 47.

The terminal 20 can be located at position that is accessible to potential employees or job applicants. For example, the terminal 20 can be located at a publicly accessible part of a facility of the employer or of a customer of the employer. The terminal 20 can be located at other publicly accessible facilities, such as governmental, recreational, or shopping facilities. Where the terminal 20 is located in a facility that is remote from the employer, it can rely on access to the internet 56 to facilitate communications with the employer's HR system 58. The terminal 20 can be permanently installed at the location or can be positioned using a temporary or portable fixture such that the terminal 20 can be easily moved and relocated.

In step 604, the terminal 20 can detect an access event initiated by an applicant. The access event can begin with an applicant entering data via the keypad 25 or a touch screen version of the display 21. The access event can also begin with the applicant swiping a card 23 through the card reader, speaking into a microphone of the audio interface 85, entering a field of view of the imaging device 80, connecting a computing device to the communications port 87, or touching the biometric reader 30. Once the terminal 20 detects the access by the applicant in step 604, the terminal can communicate instructional information to applicant for receiving credentials at step 606. For example, the terminal 20 can present visual and/or textual instructional information at the display 21. The terminal can communicate information using a speaker of the audio interface 85. The instructional information can include an overview of the application process and can request specific types of credential information for identifying the applicant, including name, social security number, address, phone number, and/or internet address. The terminal 20 can capture applicant credential information using one or more of the available functions for voice recognition using audio interface 85, text entry via the keypad 25 or the display 21, still image/video capture via the imaging device 80, and/or the communications port 87. For example, an applicant could enter a facial image via the imaging device 80, download a resume via the communications port 87, enter a telephone number via the keypad 25, provide an identification number via a magnetic card via the card reader 22, provide a fingerprint via the biometric image reader 30, and respond to audio instructions via the audio interface 85.

In step 608, the credential information can be authenticated by the terminal 20. For example, the terminal 20 can access one or more services to determine if the credential information provided by the applicant is valid and/or to determine a positive identification of the applicant. The terminal 20 can access these services directly, via the internet 56, or can make the access through the HR system 58. The terminal can store part of the credential information at the terminal 20 for use at a subsequent step in employment processing. For example, the terminal can store a fingerprint captured at the biometric reader 30 and transmit this information to the HR system for authentication only if the applicant reaches a later step in the employment process. The terminal 20 can perform the authentication directly or can request that the HR system 58 or a third party service perform the authentication. The terminal 20 can receive information form a service that can be compared to the credentials provided by the applicant. For example, the applicant can provide driver's licensing information to the terminal 20, the terminal 20 can query a remote database or service with access to department of motor vehicle information, and the terminal 20 can compare the information received form the remote database or service with the credential offered by the applicant.

If at 608 the terminal 20 is unable to authenticate the user then end the application process by returning to the original user interface at step 602. Alternatively, the terminal 20 can return to step 606 and receive additional or updated credentials from the applicant. The terminal 20 can, in turn, attempt to authenticate these credentials in step 608. The terminal 20 can employ a scheme to lockout the terminal 20 for a time period, such as a few minutes, if an applicant fails to provide proper credentials several times or if the terminal 20 otherwise detects an attempt to improperly use the terminal 20.

If at 608 the terminal 30 authenticates the credentials, then the terminal 20 receives application information at step 610. The application information can include any of a variety of information regarding the applicant's person, education, work experience, job interest, scheduling availability, and/or compensation requirements. The terminal 20 can provide a listing of required information to the applicant by presentation at the display 21, recitation over the audio interface 85, and/or transmittal using the printer 47. All or part of the required information can be presented using a posting at the location of the terminal 20 or via a brochure available at the location. The applicant can provide the application information by entering data through the keypad 25 and/or the display 21 (if a touch screen). The audio interface 85 can capture audio from the applicant. This audio can be converted to text via an audio-to-text converter operating at the terminal 20. Alternatively, the captured audio can be transmitted to the HR system 58 for conversion into text. The application information can include one or more available jobs for which the applicant has chosen to apply.

The applicant can provide information using the communications port 87. For example, the applicant can couple a computer device or a memory stick to the terminal 20. The terminal 20 can download a resume from the computer device or memory stick. The terminal 20 can transmit the downloaded resume to the HR system 58, where the downloaded resume can be stored and/or parsed for specific application information. Alternatively, the terminal 20 can parse the downloaded resume for application information. The applicant can enter specific application information using a computer device, such as a smart phone, and transfer the information into the terminal 20 via a wireless connection, such as a WiFi connection.

At step 612, the terminal can transmit the application information to the HR system 58. The application information can be maintained at the terminal 20, as local memory resources allow. The application information can subsequently be from the terminal 20 according to an information policy. Storage of information at the terminal 20 can be managed by the terminal 20 or by the HR system 58. The application information that is transmitted to the HR system 58 can be stored at the HR system 58 for use in processing the application. The HR system 58 can maintain a permanent record of the application, which can be archived for historical or legal access.

At step 614, the terminal 20 can determine if the applicant has given permission for a background check. The background check can include verification of all the information that has been provided by the applicant though the terminal 20. The background check can include verifying the authenticity of the social security number and/or insuring that the applicant is not engaged in identity impersonation. The background check can include verification of the legal status of the applicant though the Federal E-Verify system. The background check can include searching the applicant's criminal, civil court, and/or financial history. The background check can include initiation of a drug and/or alcohol screen. The background check can include verification of applicant's reported educational and work history and/or character references. The background check can be performed automatically, manually, or using a combination of automated and manual procedures. For example, the verification of legal status and financial history can be performed automatically using on-line services that are accessible to the terminal 20 and/or the HR system 58 via the internet 56. The verification of character references and work history can be performed manually by staff at the HR system.

Permission can be obtained by the terminal 20 by capturing one or more user inputs from the applicant that indicate the applicant's agreement to allow the background check to be performed by the employer. The permission generally requires some level of informed consent, where the applicant is given information describing the nature of the background checking that will be performed and then is given an opportunity to signify her agreement to permit the background check. The information can be delivered to the applicant using one or more of the communication mechanisms of the terminal 20 including the display 21, the audio interface 85, and/or a printer 47. The applicant can provide the permission to the employer by entering an electronic signature using the display 21 and/or the keypad 25. Alternatively, the applicant can give permission verbally at the audio interface 85, electronically at the communication port 87, and/or biometrically at the biometric reader 30.

If the terminal 20 confirms that the applicant has given permission for the background check at step 614, then in step 616, the terminal 20 can request the performance of the background check. If the applicant fails any part of the background check, in step 618, then the terminal can inform the applicant of a rejection of the application in step 620. In one alternative, the applicant can fail the background check if the check reveals events or subject matter that the employer finds incompatible with the applied for job. In another alternative, the background check may have been inconclusive due to lack of information. In this case, the employer can choose to pass the applicant, to fail the applicant, or to request additional information from which to make a decision. The terminal 20 can communication the rejection of the application to the applicant using one or more of the communication mechanisms of the terminal 20 including the display 21, the audio interface 85, and/or a printer 47. In one embodiment, if the applicant fails the background check in step 618, then terminal 20 and/or HR system 58 can decide, in step 638, whether to keep the application on file. In one embodiment, the terminal 20 and/or HR system 58 can be configured to always discard the application information in step 642. In another embodiment, the terminal 20 and/or HR system 58 can be configured to store a permanent copy of the application information in step 640.

If the HR system 58 determines that the applicant has passed the background check in step 618, then, in step 622, the HR system 58 will decide whether or not the applicant can be offered an immediate position. The HR system 58 can use automated and/or manual decision processes. For example, if the application is directed to a position for which the employer has one or more open requisitions, then the HR system 58 can be configured to automatically extend a provisional offer of employment at step 624 if the application meets a set of requirements, including passage of the background check. In another example, the HR system 58 can be configured to require human intervention prior to the extension of the provisional offer in step 624. In another example, the HR system 58 can be configured to require a human intervention that is preceded or followed by an automated process.

If the HR system 58 decides to not make an immediate offer, then the terminal 20 and/or the HR system 58 can decide, in step 638, whether to keep the application on file. In one embodiment, the terminal 20 and/or HR system 58 can be configured to always discard the application information in step 642. In another embodiment, the terminal 20 and/or HR system 58 can be configured to store a permanent copy of the application information in step 640. In another embodiment, the HR system 58 can be configured to maintain a copy of the application information for possible use in filling a future requisition.

If the HR system 58 decides to make an immediate offer, then the terminal 20 can present a provisional employment offer to the applicant in step 624. The terminal 20 can communication the provisional offer to the applicant using one or more of the communication mechanisms of the terminal 20 including the display 21, the audio interface 85, and/or a printer 47. In one embodiment, the offer can be extended via a human interaction with the applicant through the terminal 20. For example, the personnel from the HR system 58 can communicate directly with the applicant through the audio interface 85. In one embodiment, the offer can be a provisional offer to the extent that the employer retains a right to revoke the offer of employment for one or more reasons, including failure of the applicant to supply additional information, subsequent failure of a pre-employment drug test, or changes in business conditions.

If a provisional offer of employment is presented to the applicant at step 624, then the terminal 20 can determine if the offer has been accepted by the applicant at step 626. The terminal 20 can monitor for user inputs responsive to the presentation of the offer. For example, the terminal 20 can determine if the applicant has entered text made a selection at the display 21 and/or the keypad 25. In one embodiment, the terminal 20 can present a graphical element at the display 21, such as a button or a check box, for the applicant to indicate acceptance or rejection of the offer. In another embodiment, the terminal 20 can present a text box at the display 21 for the applicant to enter a textual response, which can include an electronic signature. In another embodiment, the terminal 20 can cause a printer 47 to print the offer. The applicant can accept or reject the offer by adding a written acceptance or rejection of the offer and a signature to the printed offer. The printed offer can then be presented to the imaging device 80, which can take a digital picture and forward this picture to the HR system 58. In another embodiment, the applicant can verbally accept or reject the offer using the audio interface 85. The terminal 20 can digitally record the applicant's answer and provide this response to the HR system 58.

If the applicant rejects the provisional offer of employment at step 626, then the terminal 20 and/or the HR system 58 can decide, in step 638, whether to keep the application on file. In one embodiment, the terminal 20 and/or HR system 58 can be configured to always discard the application information in step 642. In another embodiment, the terminal 20 and/or HR system 58 can be configured to store a permanent copy of the application information in step 640. In another embodiment, the HR system 58 can be configured to maintain a copy of the application information for possible use in filling a future requisition.

If the applicant accepts the offer in step 626, then the terminal can schedule one or more employment initiation activities with the applicant in steps 628-630. In one embodiment, the terminal 20 can schedule a day/time for the applicant to show up at a location for completing employment processing at step 630. For example, the employer can require that the applicant take and pass a physical examination prior to officially becoming an employee. The terminal 20 can communicate the required employment processing steps, locations, days, and times to the applicant based on information provided by, for example, the HR system 58. The terminal 20 can add the applicant to labor scheduling at the payroll and work management center 55 in step 632. The applicant can be provisionally added depending on completion of final employment processing activities in step 630. The terminal 20 can present upcoming work schedule information for the application at the display 21 and can cause a printer 47 to print a schedule. At step 634, the terminal can initiate compensation and benefit processing. In one embodiment, the applicant can enter information for setting up benefits, such as health insurance or life insurance. For example, the display 21 can prompt the applicant to enter information regarding beneficiaries or to respond to a health questionnaire. The information that is entered can be transmitted to the HR System 58 to be further processed and forwarded to the appropriate third parties, such as the insurance carrier for the employer.

In one embodiment, the terminal 20 can assist an employee with setting up direct depositing. For example, the terminal 20 can ask the employee if they wish to enroll in direct deposit. If the employee indicates they wish to use this feature, then the terminal can request bank account routing information. In one embodiment, the terminal 20 can display an exemplary personal check and can highlight the various routing and account information that is required. The applicant can enter the bank routing information via the display 21 and/or keypad. After the direct deposit information is entered and confirmed, the terminal 20 can transmit the information to the HR system 58 for further processing and forwarding to an appropriate third party, such as a bank or credit union. The terminal device 20 can provide a record of the direct deposit information to the employee via, for example, the printer 47 or via an email message or text message.

Upon reviewing the aforementioned embodiments, it would be evident to an artisan with ordinary skill in the art that said embodiments can be modified, reduced, or enhanced without departing from the scope and spirit of the claims described below. For example, one or more of the exemplary embodiments can enable an employment application to be captured by the terminal 20, including, for example voice, video, text, and/or files from a computer device, and stored by the terminal 20. Later, the HR system 58 can access and process the application. In this example, the terminal 20 can be utilized as a depository for the application, where HR personnel may not be immediately available and the HR system 58 is not configured to automatically process the application without human intervention.

In one embodiment, the terminal 20 can be used by an employee who is seeking to change jobs within the employer. For example, the employer may have posted a set of job openings, which it would consider filling by reassigning current employees. A current employee can see a listing of the job openings at the display 21 and can initiate the process of entering information to apply for an opening. In this embodiment, the employee could use an employer issued badge or identity card as the credential for entering the process. The background checking process can be abbreviated or eliminated for the existing employee.

In one embodiment, the terminal 20 can initiate the process for issuing an employee badge or identity card for the applicant. After the applicant accepts the offered position, the terminal can instruct the applicant to face the imaging device 80 in a specific orientation consistent with the needs of the badge/identity card. After taking the applicant's picture, the terminal 20 can transmit the picture to the HR system 58 for further processing and generation of the badge/identity card. In one embodiment, the terminal 20 can issue a temporary badge/identity card to the applicant via the printer 47. In one embodiment, the terminal 20 can issue a proof of accepted employment to the applicant after the offer is accepted.

FIG. 6B depicts an illustrative method 650 that operates in portions of the devices and systems of one or more of FIGS. 1-5, 8, and 9, and the method of FIG. 7. Method 650 can begin at 652 with receive a credential from an applicant. For example, the employee can use the card reader 22 to swipe a badge or an identification card or the employee can use the fingerprint reader 30 or the audio interface 85 to provide a fingerprint or a voice sample as a credential. In step 654, the terminal 20 can authenticate the provided credential locally or can transmit digital data from the credential to a central authentication process for authentication. If the credential is authenticated, in step 656, then the terminal 20 can determine if a verification of logged hours worked is scheduled. If the verification is scheduled in step 656, then the terminal can proceed to steps 658-664 to verify the hours. If the verification is not scheduled, then the terminal 20 can determine if the employee has requested a verification of hours using, for example, an hours worked verification function. If the employee does not request verification of hours, at step 670, then the terminal 20 can end the verification process. If the employee does request hours worked verification, at step, 670, then the terminal can proceed to steps 658-664 to verify the hours.

In step 658, the terminal 20 can request and receive the log of hours worked for this employee from the payroll and work management server 55. In one embodiment, the terminal 20 can provide one or more means for the employee to verify the log of hours worked. If the employee accepts the log as correct, in step 662, then the terminal 20 can provide the verification to the payroll and work management server 55. Conversely, if the employee rejects the log, then the terminal 20 can provide the rejection to the payroll and work management server 55, in step 664. If the employee rejects the log of hours worked (or refuses to answer), then the terminal 20 can notify management to intervene and resolve the dispute in step 666. The terminal 20 can also lock out further check-in/check-out by the employee until the employee either verifies the hours worked or management resolves the dispute in step 668.

FIG. 7 depicts an illustrative method 700 that operates in portions of the devices and systems of one or more of FIGS. 1-5, 8, and 9, and the method of FIG. 6. Method 700 can begin at 702 with a user attempting to access terminal 20. Access authentication can be performed by the terminal 20 on the user, such as biometric authentication, using one or more of fingerprint reading, voice recognition and facial recognition. In one embodiment, the terminal 20 can utilize fingerprint reader 130 to authenticate the user. The authentication can be based on locally stored data, such as fingerprint identification information stored in the memory of the terminal 20, such as in a user profile. The exemplary embodiments also contemplate the authentication process retrieving data from a remote source, such as the center 55 or the HR system 58.

If at 704 the terminal 20 is unable to authenticate the user then at 706 the terminal 20 can attempt an alternative authentication. For instance, after attempting a fingerprint reading authentication which is unsuccessful, the terminal 20 can capture one or more images of the user utilizing the imaging device 80. In one embodiment, authentication can be performed via facial recognition analysis performed on the captured image(s) by the terminal 20. In another embodiment, the captured image(s) can be transmitted to a remote recipient for authentication, such as to the HR system 58 for identification of the employer. The identification can be based on a recognition analysis performed by a remote server at the HR system 58 and/or can be based on a review by HR personnel comparing the captured image(s) with image(s) of the user stored or otherwise accessible to the HR personnel. In another embodiment, the captured images can be part of a video conference that is provided between the terminal 20 and a video conferencing device at the HR system 20 (or another remote authentication location) where the user's identity can be authenticated during the video conference by personnel participating in the video conference. Other authentication techniques are also contemplated, including use of the bank card 23 in conjunction with the primary and/or secondary authentication techniques.

If after attempting the first and second authentication techniques the user is still not identified then a security message or notice can be issued at 708. For example, security personnel located at the facility where the terminal 20 is located can be provided with an alert message. In one embodiment, where the authentication attempt utilizes a bank card 23 associated with a legitimate user but the authentication attempt(s) fail then one or more communication devices 300 of the legitimate user can be provided with the alert message. It should be understood that while the exemplary embodiment illustrates use of a primary and second authentication process, terminal 20 can utilize any number of authentication processes before terminating the access attempts and/or notifying security, including a single failed authentication attempt based on only one authentication process. In another embodiment, the secondary authentication process can be based on captured audio signals of the user, including based on voice recognition and/or a voice conference with remote personnel. For instance, the display 21 can provide a prompt requesting the user to speak a particular sentence into the audio interface 85 or the terminal 20 can initiate a voice conference between the user and personnel at a remote authentication site. The voice recognition process can be performed locally by the terminal 20, such as based on locally stored voice identification data in a user profile or can be performed remotely, including automatically via voice recognition or via the voice conference.

If the user is authenticated then at 710 a self-service menu can be presented by the terminal 20, such as at the display 21. It should be understood that the presentation of the self-service menu can include graphical and/or audible options (e.g., emitted through audio interface 85). In one embodiment, the presentation of the menu can be based on user preferences, such as identified in the user profile 450. For instance, a user may desire to hear the menu and selectable options rather than read them on the display 21 which can result in the terminal 20 presenting the options via the audio interface 85. The self-service menu can include selectable options for performing a number of tasks, including scheduling requests, retrieving a current schedule including PTO days, cancelling a previously requested PTO day, rolling over or cashing in an unused PTO day, payroll tasks, supply ordering, checking-in or checking-out, updating user profiles, seeking HR information and so forth.

At 712, if the user makes a selection of an option which is not a scheduling request then method 700 can proceed to 714 to provide other self-service options as described above. Once the user is done with utilizing the terminal 20, then access can be terminated at 716. If on the other hand, the user selects an option for making a scheduling request at 712 then at 718 the terminal 20 can present scheduling options to the user. The scheduling options can be presented graphically via the display 21 and/or audibly via the audio interface 85.

In one embodiment, scheduling information can be obtained at 720 to facilitate an analysis and generation of the available scheduling options. The analysis of available scheduling options can be performed by the terminal 20 and/or performed by a remote source, such as the center 55 and/or the HR system 58. The scheduling information can be obtained locally (e.g., from the terminal 20 or from a local memory at the facility such as from another terminal at the same facility or a server of the facility) and/or remotely (e.g., from one or both of the center 55 and/or the HR system 58). The scheduling information can include various information, such as employment schedule data for other users (e.g. co-workers, subordinates or supervisors of the user) that are associated with the user, a work load associated with the user, a work load associated with one or more of the other users, a work efficiency associated with the user, a work efficiency associated with one or more of the other users, a skill set associated with the user and/or a skill set associated with one or more of the other users. In one embodiment at 722, all or a portion of the scheduling information can be retrieved from user profiles associated with the user and/or the other users.

The scheduling options can be presented using various techniques, such as showing calendars with various scheduling scenarios. The scheduling scenarios can be determined by the terminal 20 and/or remotely, including by remote devices at the center 55 and/or the HR system 58, based on the scheduling information. One of the scenarios can be the scheduling or PTO days that are inputted by the user via a user interface of the terminal 20 (e.g., the keypad 20, a touch-sensitive display 21 and/or the audio interface 85). Other scenario can be alternative schedules generated based on the scheduling information, such as to avoid conflicting with PTO days of the other users, to avoid being understaffed based on a particular expected workload for a particular time period, to avoid not having the necessary skilled employees available at a particular time period, and so forth. The scheduling options can be in calendar form where each is graphically distinctive to facilitate understanding of the options.

At 724, the terminal 20 can receive from the user via a user interface of the terminal, a scheduling selection from among the presented options. The scheduling selection can be transmitted or otherwise provided to the HR system 58 for HR review and approval at 726. The HR review can be based on a number of factors, including employer policy, available PTO days, minimum amount of notice for scheduling change, and so forth. The HR review can be an automated process, such as performed by an HR server according to policy and rules that are stored in the HR server for analyzing electronic scheduling selections received from a terminal 20. The HR review can also be based on a review by HR personnel.

At 728 if HR approval is denied then method 700 can return to step 718 to present other scheduling options. The alternative scheduling options can be the same alternative options previously presented and/or can include new alternative options, such as generated based on information provided with the HR denial. For instance, the HR denial can include information describing a new employer policy that does not allow PTO days to be taken during a certain time period, such as during a heavy workload week of the year. This may be a new policy that has not been updated into the scheduling information and thus the original scheduling options may have been generated without the benefit of these criteria. The new alternative scheduling options can be generated based additionally on this new employer policy. The original scheduling information and the HR information (e.g., a reason for denial), if any, provided with the HR denial can be in a format that can be consumed by the terminal 20 or another device that is generating the scheduling options so that the scheduling options can, in one embodiment, be generated without user intervention. However, one or more of the exemplary embodiments also contemplate scheduling options being generated with the assistance of scheduling personnel.

If on the other hand, HR approval is provided at 728 then the terminal 20 can provide a printed confirmation at 730. The printed confirmation of HR approval for the scheduling selection can then be utilized by the user to obtain approval from his or her supervisor. For instance, the user can take the printed confirmation to the supervisor that is available on the floor of the facility and have the supervisor sign or otherwise place indicia of approval (or denial) on the printed confirmation. In one embodiment, the printed confirmation can include information related to the scheduling selection, such as the schedule of the user's co-workers and subordinates for the relevant time period (e.g., for the PTO day that is being requested), the workload expected for that day, the skill sets of the available workers and so forth. In one embodiment, to facilitate the user tracking the supervisor down for the approval, a message can be sent from the terminal 20 to the communication device 300 of the supervisor, such as a Short Messaging Service (SMS) notice of the scheduling request. Other forms of notice can also be provided, including email, automated voice message, Multimedia Messaging Service (MMS) and so forth. The presence system 350 and supervisor preferences stored in a user profile associated with the supervisor can be utilized to facilitate providing the message of the pending scheduling selection to the supervisor. Once the user obtains the supervisor indicia on the printed confirmation, the user can at 732 utilize the terminal 20 to capture an image (e.g., via scanning or image capture using the imaging device 80) of the printed confirmation with the supervisor indicia. While the user is seeking the signature of the supervisor, the terminal 20 can temporarily log the user out of the terminal or the user can terminate access to the terminal and then log back in once the supervisor's signature is obtained. In one embodiment, the terminal 20 can save the place in the scheduling process so that upon being re-authenticated as in steps 702-706, the user can resume with the scheduling process without going through steps 710-730.

If at 734 the supervisor's indicia indicate a denial of the scheduling selection then method 700 can return to 718 to provide more of the alternative scheduling options. If on the other hand the supervisor's indicia indicates approval of the scheduling request then at 736 a printed confirmation of the scheduling selection, which includes both the HR approval and recognition of the supervisor's approval, can be provided to the user.

The supervisor's indicia can be analyzed in a number of different ways by different devices and/or personnel (e.g., terminal 20, server or personnel at center 55 and/or server or personnel at HR system 58) to determine if the supervisor has approved the scheduling selection. For instance, image recognition can be applied to a supervisor signature on the printed confirmation to determine if the signature is authentic where supervisors only sign if they are approving. In another embodiment, image recognition can be used to authenticate the supervisor's signature on the printed confirmation and to further recognize information written onto the printed confirmation by the supervisor, such as the word “approved”, the word “denied” and/or an explanation for the denial. In one embodiment, the explanation for the denial can be recognized, translated into text, parsed and then utilized for adjusting the scheduling options, such as where the supervisor notes that a particular day has historically been busy resulting in the scheduling options being adjusted (e.g., by the terminal 20) to remove the busy day as an available PTO day. The parsed information can be provided to the particular device performing the generation of the scheduling options, such as the terminal 20, the center 55 and/or the HR system 58.

At 738, the scheduling information can be adjusted based on the approval of the scheduling selection. In one embodiment, the scheduling information adjustment can be performed in real-time so that another employee who subsequently seeks PTO days or other scheduling requests has the benefit of the most up-to-date scheduling information. In another embodiment, scheduling selections that have been made and approved by HR but have not yet been approved by the supervisor can be utilized for temporary adjustments to the scheduling information. In this way, a supervisor's delay in providing approval will not result in penalizing employees with pending scheduling selections or requests where a later requested scheduling of another employee has overlapping PTO days or is otherwise conflicting. Once the supervisor's approval or denial is obtained, the scheduling information can be permanently adjusted accordingly. Following the adjustment of the scheduling information, method 700 can return to step 710 to provide the user with access to other self-service tasks.

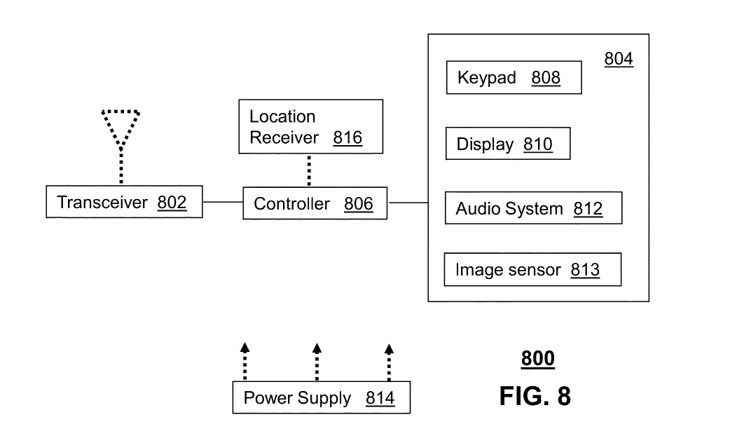

FIG. 8 depicts an exemplary embodiment of a communication device 800. Communication device 800 can serve in whole or in part as an illustrative embodiment of user endpoint devices, such as the communication devices 300 of the user, the co-workers, the subordinates, the supervisors and/or other entities, such as depicted in FIGS. 3-4 and/or as utilized in the methods of FIGS. 6-7. The communication device 800 can function as a caller and/or callee's end user device (e.g., for a video or telephone conference that includes a schedule requesting user and a supervisor) that can participate in a voice call, video call and/or messaging session regardless the compatibility of the devices and/or the compatibility of the networks in which the devices are operating. The communication device 800 can comprise a wireline and/or wireless transceiver 802 (herein transceiver 802), a user interface (UI) 804, a power supply 814, a location receiver 816, and a controller 806 for managing operations thereof. The transceiver 802 can support short-range or long-range wireless access technologies such as Bluetooth, WiFi, Digital Enhanced Cordless Telecommunications (DECT), and/or other cellular communication technologies, just to mention a few. Cellular technologies can include, for example, CDMA-1X, UMTS/HSDPA, GSM/GPRS, TDMA/EDGE, EV/DO, WiMAX, SDR, LTE, as well as other next generation cellular wireless communication technologies as they arise. The transceiver 802 can also be adapted to support circuit-switched wireline access technologies (such as PSTN), packet-switched wireline access technologies (such as various forms of IEEE 802.11 networking technologies, TCP/IP, VoIP, etc.), and combinations thereof.

The UI 804 can include a depressible or touch-sensitive keypad 808 with a navigation mechanism such as a roller ball, a thumbwheel, a joystick, a mouse, or a navigation disk for manipulating operations of the communication device 800. The keypad 808 can be an integral part of a housing assembly of the communication device 800 or an independent device operably coupled thereto by a tethered wireline interface (such as a USB cable) or a wireless interface supporting for example Bluetooth. The keypad 808 can represent a numeric dialing keypad commonly used by phones, and/or a QWERTY keypad with alphanumeric keys used by smart phones. The UI 804 can further include a display 810 such as monochrome or color LCD (Liquid Crystal Display), OLED (Organic Light Emitting Diode) or other suitable display technology for conveying images to an end user of the communication device 800. In an embodiment where the display 810 is touch-sensitive, a portion or all of the keypad 808 can be presented by way of the display 1010 with navigation features.

The UI 804 can also include an audio system 812 that utilizes common audio technology for conveying low volume audio (such as audio heard only in the proximity of a human ear) and high volume audio (such as speakerphone for hands free operation). The audio system 812 can further include a microphone for receiving audible signals of an end user. The audio system 812 can also be used for voice recognition applications. The UI 804 can further include an image sensor 813 such as a charged coupled device (CCD) camera for capturing still or moving images.

The power supply 814 can utilize common power management technologies such as replaceable and rechargeable batteries, supply regulation technologies, and charging system technologies for supplying energy to the components of the communication device 800 to facilitate long-range or short-range portable applications. The location receiver 816 can utilize common location technology such as a global positioning system (GPS) receiver capable of assisted GPS for identifying a location of the communication device 800 based on signals generated by a constellation of GPS satellites, thereby facilitating common location services such as navigation. Location data from location receiver 816 can be provided to presence system 350 and/or electronic terminal 20 to facilitate communication between the user of the terminal and another entity, such as a supervisor and/or a user, who has requested a scheduling decision from the supervisor. The location data can be utilized in a number of different ways, including initiating a conference to obtain a scheduling decision or determining an availability of an entity, such as a supervisor, a user who has requested a scheduling decision from the supervisor or other employees participating in a scheduling negotiation with the user requesting the scheduling decision.

The communication device 800 can use the transceiver 802 to also determine a proximity to a cellular, WiFi, Bluetooth, or other wireless access points by common sensing techniques such as utilizing a received signal strength indicator (RSSI) and/or a signal time of arrival (TOA) or time of flight (TOF). The controller 806 can utilize computing technologies such as a microprocessor, a digital signal processor (DSP), and/or a video processor with associated storage memory such a Flash, ROM, RAM, SRAM, DRAM or other storage technologies.

The communication device 800 can be adapted to perform the functions of one or more of the communication or user end point devices of FIGS. 3-4. It will be appreciated that the communication device 800 can also represent other common devices that can operate in one or more of the communication systems of FIGS. 3-4 and the methods of FIG. 6-7.

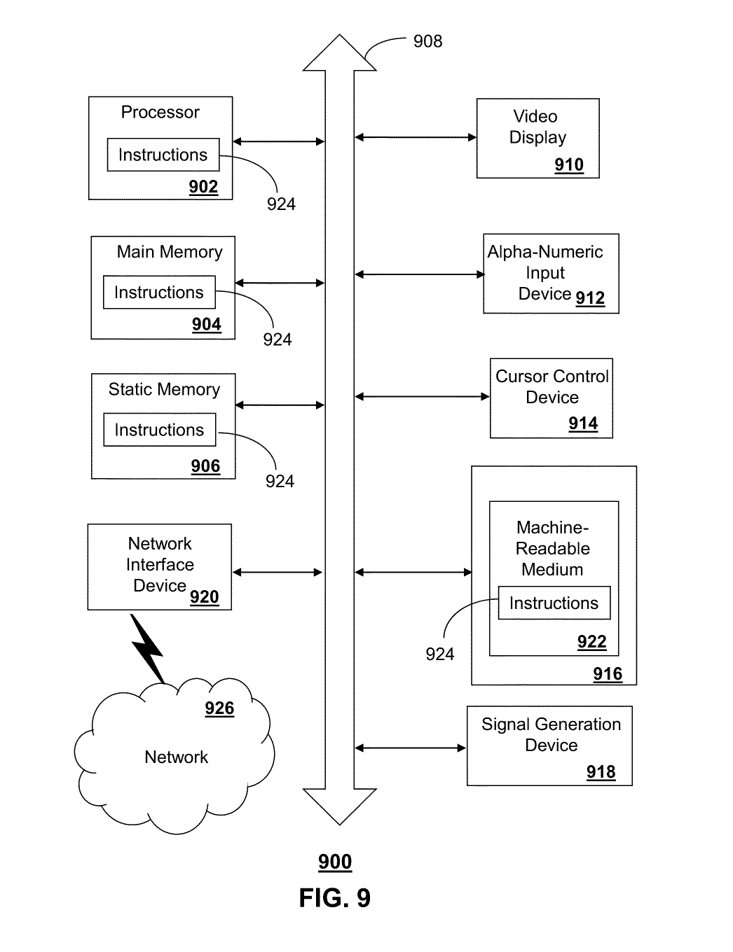

FIG. 9 depicts an exemplary diagrammatic representation of a machine in the form of a computer system 900 within which (e.g., stored on a non-transitory storage medium) a set of instructions, when executed, may cause the machine to perform any one or more (or portions thereof) of the methods discussed above. One or more instances of the machine can operate, for example, as the electronic terminal 20, the payroll and work management center 55, the HR system 58, the central processing server array 101 and/or the presence system 350. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. It should be understood that the exemplary embodiments include one or more functions of an individual device being distributed among a plurality of devices.

The machine may comprise a server computer, a client user computer, a personal computer (PC), a tablet PC, a smart phone, a laptop computer, a desktop computer, a control system, a network router, switch or bridge, or any machine capable of executing a set of instructions (sequential or otherwise) that specify actions to be taken by that machine. It will be understood that a communication device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

The computer system 900 may include a processor 902 (e.g., a central processing unit (CPU), a graphics processing unit (GPU, or both), a main memory 904 and a static memory 906, which communicate with each other via a bus 908. The computer system 900 may further include a video display unit 910 (e.g., a liquid crystal display (LCD), a flat panel, or a solid state display. The computer system 900 may include an input device 912 (e.g., a keyboard), a cursor control device 914 (e.g., a mouse), a disk drive unit 916, a signal generation device 918 (e.g., a speaker or remote control) and a network interface device 920.

The disk drive unit 916 may include a tangible computer-readable storage medium 922 on which is stored one or more sets of instructions (e.g., software 924) embodying any one or more of the methods or functions described herein, including those methods illustrated above. The instructions 924 may also reside, completely or at least partially, within the main memory 904, the static memory 906, and/or within the processor 902 during execution thereof by the computer system 900. The main memory 904 and the processor 902 also may constitute tangible computer-readable storage media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

While the tangible computer-readable storage medium 922 is shown in an example embodiment to be a single medium, the term “tangible computer-readable storage medium” should be taken to include a single medium or multiple media (e.g., a centralized or distributed database, and/or associated caches and servers) that store the one or more sets of instructions. The term “tangible computer-readable storage medium” shall also be taken to include any non-transitory medium that is capable of storing or encoding a set of instructions for execution by the machine and that cause the machine to perform any one or more of the methods of the present disclosure.

The term “tangible computer-readable storage medium” shall accordingly be taken to include, but not be limited to: solid-state memories such as a memory card or other package that houses one or more read-only (non-volatile) memories, random access memories, or other re-writable (volatile) memories, a magneto-optical or optical medium such as a disk or tape, or other tangible media which can be used to store information. Accordingly, the disclosure is considered to include any one or more of a tangible computer-readable storage medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are from time-to-time superseded by faster or more efficient equivalents having essentially the same functions. Wireless standards for device detection (e.g., RFID), short-range communications (e.g., Bluetooth, WiFi, Zigbee), and long-range communications (e.g., LTE, WiMAX, GSM, CDMA) are contemplated for use by computer system 900.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. One or more of the method steps described herein can be removed, performed in another sequence, and/or performed individually or simultaneously. Other method steps can also be added to the techniques described herein. Figures are also merely representational and may not be drawn to scale. Certain proportions thereof may be exaggerated, while others may be minimized. Accordingly, the specification and drawings are to be regarded in an illustrative rather than a restrictive sense.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An apparatus, comprising:
a memory to store computer instructions;
a user interface;
a display device; and
a controller circuit coupled to the memory, the user interface and the display device, wherein the controller circuit, responsive to performing the computer instructions, performs operations comprising:
presenting a self-service graphical user interface on the display device comprising instructions to apply for a job opening;
receiving application information for the job opening inputted by an applicant via the user interface;
receiving a permission to perform a background check inputted by the applicant via the user interface;
transmitting the permission to a human resources system;
receiving a notification from the human resources system;
determining whether the notification comprises a job offer to the applicant; and
responsive to a determination that the notification comprises the job offer:
presenting the job offer to the applicant via the self-service graphical user interface;
receiving an acceptance of the job offer inputted by the applicant via the user interface thereby establishing the applicant as a worker;
capturing a check-in time and a check-out time for the worker via the user interface;
calculating a work time corresponding to a period between the check-in time and the check-out time; and
transmitting the work time to a payroll system.

2. The apparatus of claim 1, wherein the controller circuit further performs operations comprising:
receiving a credential from the applicant via the user interface;
transmitting the credential to the human resources system;
receiving a credential notification from the human resources system subsequent to the human resources system performing an authentication on the credential; and
enabling the receiving of the application information for the job opening responsive to the credential notification indicating that the credential passed the authentication.

3. The apparatus of claim 2, wherein the credential is received at a magnetic card reader of the user interface.

4. The apparatus of claim 2, wherein the credential is received at a biometric reader of the user interface.

5. The apparatus of claim 1, wherein the controller circuit further performs operations comprising transmitting the application information of the applicant to the human resources system.

6. The apparatus of claim 1, wherein the background check comprises checking a criminal record of the applicant.

7. The apparatus of claim 1, wherein the background check comprises checking a legal status of the applicant.

8. The apparatus of claim 1, wherein the controller circuit further performs operations comprising:
determining whether the notification comprises a failure of the background check; and
presenting a notice of the failure of the background check to the applicant via the self-service graphical user interface responsive to determining the failure of the background check.

9. The apparatus of claim 8, wherein the controller circuit further performs operations comprising discarding the application information responsive to determining that the notification indicates the failure of the background check.

10. The apparatus of claim 1, wherein the controller circuit further performs operations comprising:
receiving a request for scheduling inputted by the worker via the user interface;
obtaining scheduling options from a scheduling system responsive to the request for scheduling, wherein the scheduling options comprise employment schedule data for other workers that are associated with the worker; and
presenting the scheduling options on the display device.

11. The apparatus of claim 10, wherein the controller circuit further performs operations comprising:
receiving a scheduling selection from among the scheduling options, wherein the scheduling selection is inputted by the worker via the user interface;
providing the scheduling selection to the scheduling system for evaluation;
receiving an approval associated with the scheduling selection from the scheduling system; and
providing a printed confirmation of the approval.

12. The apparatus of claim 1, wherein the controller circuit further performs operations comprising scheduling the worker for a further employment processing responsive to receiving the acceptance of the job offer.

13. The apparatus of claim 1, wherein the controller circuit further performs operations comprising:
capturing an image of the worker responsive to receiving the acceptance of the job offer;
generating an employee identification based on the image that is captured; and
printing the employee identification at a printer coupled to the user interface.

14. A computer-readable storage medium comprising computer instructions which, responsive to being executed by a processor, cause the processor to perform operations comprising:
presenting a self-service graphical user interface comprising instructions to apply for a job opening at a display device of a time clock;
receiving application information for the job opening inputted via a user interface of the time clock;
transmitting the application information to a human resources system;
receiving a notification from the human resources system responsive to transmitting the application information;
determining whether the notification comprises a job offer; and
responsive to a determination that the notification comprises the job offer:
presenting the job offer via the self-service graphical user interface;
receiving an acceptance of the job offer inputted via the user interface thereby establishing an applicant as a worker;
capturing a check-in time and a check-out time for the worker via the user interface; and
calculating a work time corresponding to a period between the check-in time and the check-out time.

15. The computer-readable storage medium of claim 14, wherein the processor further performs operations comprising:
receiving a permission to perform a background check inputted by the applicant via the user interface; and
transmitting the permission to the human resources system for performing the background check.

16. The computer-readable storage medium of claim 15, wherein the processor further performs operations comprising:
determining whether the notification comprises a failure by the applicant of the background check; and
presenting a notice of the failure of the background check to the applicant via the self-service graphical user interface responsive to determining the failure of the background check.

17. The computer-readable storage medium of claim 14, wherein the processor further performs operations comprising:
receiving a request for scheduling inputted by the worker via the user interface;
obtaining scheduling options from a scheduling system responsive to the request for scheduling, wherein the scheduling options comprise employment schedule data for other workers that are associated with the worker; and
presenting the scheduling options on the display device.

18. The computer-readable storage medium of claim 14, wherein the processor further performs operations comprising:
receiving a credential from the applicant via the user interface;
transmitting the credential to the human resources system;
receiving a credential notification from the human resources system subsequent to the human resources system performing an authentication on the credential; and
enabling the receiving of the application information for the job opening responsive to the credential notification indicating that the credential passed the authentication.

19. A method, comprising:
transmitting to a human resources system, by a time clock device comprising a processor, application information and permission to perform a background check for a job opening, wherein the application information and the permission are inputted via a user interface;
presenting, by the time clock device, a job offer from the human resources system via a graphical user interface;
receiving, by the time clock device, an acceptance of the job offer via the user interface thereby establishing an applicant as a worker;
capturing, by the time clock device, work time information for the worker via the user interface;
transmitting, by the time clock device, the work time information to a payroll system;
receiving, by the time clock device, a log of hours worked by the worker during a period of time;
presenting, by the time clock device, the log of hours worked;
receiving, by the time clock device, a verification of the log of hours worked; and
transmitting, by the time clock device, the verification of the log of hours worked.

20. The method of claim 19, further comprising:
receiving, by the time clock device, a refusal to verify the log of hours worked; and
transmitting, by the time clock, a notification to a managing device responsive to the receiving of the refusal.
